(19) United States
(12) Patent Application Publication
(10) Pub. No.: US 2006/0277224 A1
(43) Pub. Date: Dec. 7, 2006

(54) Synchronizing arbitrary data using a flexible schema

(75) Inventors: Omar A. Aftab, Redmond, WA (US); Zhidong Yang, Bellevue, WA (US); Michael A. Foster, Bothell, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/146,686

(22) Filed: Jun. 7, 2005

(51) Int. Cl. G06F 17/30

(52) U.S. Cl. 707/201

(57) ABSTRACT

A schema definition module can specify an arbitrary schema that is used for data synchronization between a server and a client. At any time, the schema definition module can modify a current schema to add or remove support for an arbitrary set of data. Data synchronization continues transparently with the modified schema. Methods of use are also provided.

### BACKGROUND

Mobile computing devices such as personal digital assistants (“PDAs”), personal information managers (“PIMs”), cellular telephones, and other devices are commonly used in conjunction with a personal computer. The personal computer is commonly paired with one or more mobile computing devices and often acts as a backup data repository for information stored on the mobile computing device. Data stored on the mobile computing device is typically synchronized with data stored on the personal computer in response to a command from a user.

As mobile computing devices acquire increased processing power and other computing resources, capabilities of those devices have also increased. Many current mobile computing devices can operate mobile versions of programs that formerly were only available on a personal computer because of the need for relatively large amounts of computing power. Users of mobile computing devices that operate mobile versions of desktop software such as word processors, email and scheduling programs, and spreadsheets, among others, can use documents created by those desktop programs on mobile computing devices.

Desktop programs also have increased in their capabilities. Among those capabilities now present is the ability to modify a data format or schema. For example, some scheduling programs include the ability to add, delete, or change the standard schema for contacts. A generic format for a contact commonly includes fields for the name of a person, an address, and a telephone number. In a medical context, a doctor using a mobile computing device may store information for his patients in his scheduling program and may wish to add a field for the blood type of a contact. Current desktop scheduling programs can allow the doctor to add this field.

Current mobile versions of desktop software lack the ability to allow a user to modify the schema of data stored on a mobile computing device. As with the previous example, when the doctor synchronizes his mobile computing device with his personal computer, the scheduling software of the mobile computing device expects data from the desktop computer to adhere to a predefined schema. The doctor has changed that schema on the desktop version of his scheduling software, creating a mismatch between schemas. This mismatch can cause data loss and other problems.

Current systems lack the ability to discover schema changes and synchronize schemas to ensure that both a mobile computing device and a personal computer share a common schema. Synchronization of information is typically performed at the level of an individual data item. A data item is either current or it is not. If current, the item is left alone. If not current, the item is overwritten with data from a corresponding current data item. Current systems also lack the ability to allow users to change schemas on mobile computing devices. Systems with these capabilities can provide valuable data management capabilities to users of mobile computing devices.

### SUMMARY

The following presents a simplified summary in order to provide a basic understanding. This summary is not an extensive overview. It is neither intended to identify key or critical elements of the invention nor to delineate scope. Its sole purpose is to present some concepts in a simplified form as a prelude to a more detailed description that is presented later. Additionally, section headings used herein are provided merely for convenience and should not be taken as limiting in any way.

A flexible schema update system is provided. The flexible schema update system allows a user to vary or modify a data schema of a mobile computing device. Upon synchronizing data with a server, the updated schema can be sent to the other device full synchronization of all data can occur.

A system that allows for data synchronization using a flexible schema is provided. The system can track changes at below record level and perform a multi-stage synchronization process so that data or schema changes are not lost by overwriting data.

A flexible schema update system can employ the services of a schema server to locate a custom or previously created schema that can be used to update schemas of a mobile device and a server. The system can also use various security and authentication components to ensure integrity of data and use.

The disclosed and described components and methods comprise the features hereinafter fully described and particularly pointed out in the claims. The following description and the annexed drawings set forth in detail certain illustrative examples. These examples are indicative, however, of but a few of the various ways in which the disclosed and described components and methods can be implemented. The disclosed and described components and methods are intended to include all such examples and their equivalents. Other examples and minor modifications to examples will become apparent from the following detailed description when considered in conjunction with the drawings.

### BRIEF DESCRIPTION OF THE DRAWINGS

FIG. 1 is a system block diagram of a flexible schema management system.

FIG. 2 is a system block diagram of a schema manager.

FIG. 3 is a block diagram that illustrates corresponding client and server data records at different stages in time.

FIG. 4 is a system block diagram of a flexible schema synchronization system.

FIG. 5 is a system block diagram of a secure flexible schema and synchronization system.

FIG. 6 is a system block diagram of a secure authentication system including schema synchronization capabilities.

FIG. 7 is a system block diagram of a schema update system.

FIG. 8 is a portion of a flow diagram that depicts a method that can be used.

FIG. 9 is a continuation of the flow diagram of FIG. 8.

FIG. 10 is a flow diagram depicting a method that can be used.

FIG. 11 is a flow diagram of a method that can be used.

FIG. 12 is a flow diagram of a method that can be employed.

FIG. 13 is a flow diagram of a method that can be used.

FIG. 14 is a system block diagram of an exemplary networking environment.

FIG. 15 is a schematic diagram of an exemplary operating environment.

### DETAILED DESCRIPTION

As used in this application, the terms “component,” “system,” “module,” and the like are intended to refer to a computer-related entity, such as hardware, software (for instance, in execution), and/or firmware. For example, a component can be a process running on a processor, a processor, an object, an executable, a program, and/or a computer. Also, both an application running on a server and the server can be components. One or more components can reside within a process and a component can be localized on one computer and/or distributed between two or more computers.

Disclosed components and methods are described with reference to the drawings, wherein like reference numerals are used to refer to like elements throughout. In the following description, for purposes of explanation, numerous specific details are set forth in order to provide a thorough understanding of the disclosed subject matter. It may be evident, however, that certain of these specific details can be omitted or combined with others in a specific implementation. In other instances, certain structures and devices are shown in block diagram form in order to facilitate description. Additionally, although specific examples set forth may use terminology that is consistent with client/server architectures or may even be examples of client/server implementations, skilled artisans will appreciate that the roles of client and server may be reversed, that the disclosed and described components and methods are not limited to client/server architectures and may be readily adapted for use in other architectures, specifically including peer-to-peer (P2P) architectures, without departing from the spirit or scope of the disclosed and described components and methods. Further, it should be noted that although specific examples presented herein include or reference specific components, an implementation of the components and methods disclosed and described herein is not necessarily limited to those specific components and can be employed in other contexts as well.

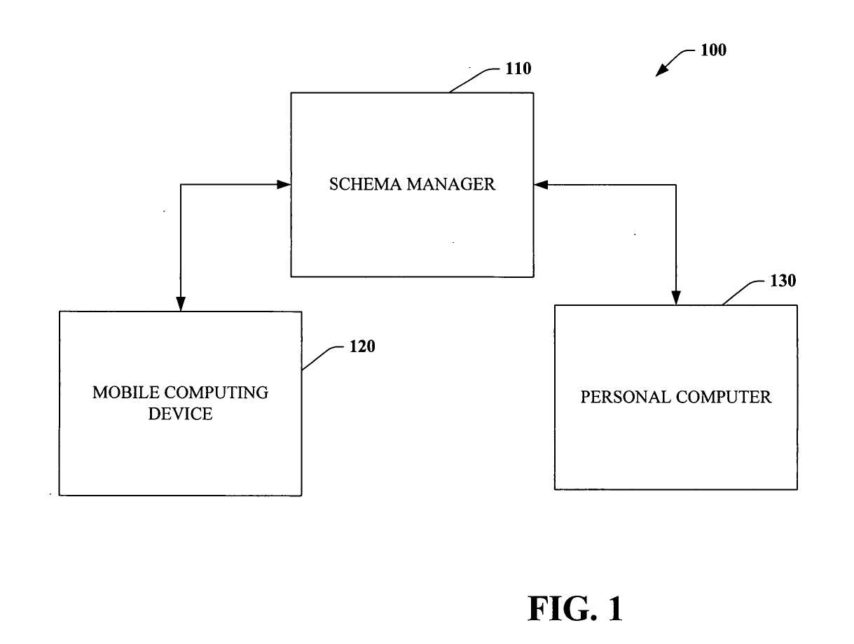

FIG. 1 is a system block diagram of a flexible schema management system 100. The flexible schema management system can provide a framework within or upon which a mobile computing device, or a personal computer, or both, can modify a schema that is used to format data that is exchanged between the mobile computing device and the personal computer. Current systems lack an ability for a user to modify a schema to handle arbitrary data types. Among other things, the flexible schema management system 100 provides that ability.

The flexible schema management system 100 includes a schema manager 100. The schema manager 100 is a component that can compare a first schema, for example a schema on a mobile computing device, with a second schema, for instance a schema on a personal computer, and modify each so that the two schemas match. Additionally or alternatively, the schema manager 110 can create a third schema that is a superset of both the first schema and the second schema. The third schema can be used to replace both the first schema and the second schema for additional data transfer operations between a mobile computing device and a personal computer.

Also included in the flexible schema management system 100 is a mobile computing device 120. The mobile computing device 120 can be a cellular telephone, a personal digital assistant (“PDA”), a personal information manager (“PIM”), a dual mode device such as a combination telephone—PDA, or even a portable computer such as a palmtop or laptop computer, among others. Devices of this type in a data synchronization scheme such as the one disclosed herein commonly act as, and are often referred to, the client in a client-server architecture. It should be noted, however, that references to clients, servers, and the like are used for convenience and ease of discussion only. Such references are not intended to, and do not, limit any specific example or claimed invention to a client-server architecture.

A personal computer 130 can connect to the schema manager 110 to obtain the services provided by the schema manager 110. The personal computer 130 can be a desktop computer, a laptop computer, a workstation, or another suitable computer. Devices of this type in a data synchronization scheme such as the one disclosed herein commonly act as, and are often referred to, the server in a client-server architecture. As with use of the term client, it should be noted that references to servers are used for convenience and ease of discussion only. Such references are not intended to, and do not, limit any specific example or claimed invention to a client-server architecture.

In the example shown in FIG. 1, both the mobile computing device 120 and the personal computer 130 can access the schema manager 110. In an alternate implementation, the mobile computing device 120 and the personal computer 130 can each have an associated schema manager that can cooperate with the schema manager associated with the other device. The two schema managers can identify differences in a schema of another device and can make changes to a schema of the device with which it is associated to synchronize or match the two schemas or to create a third schema that includes all the attributes of the original two schemas. Alternatively or additionally, a schema that is a subset of one or a combination of both of the original schemas can be created. Although later examples focus on changing attributes of a schema or extending a schema, unless specified in the context of a particular example, the previously described variations in schema creation are possible with any and all of the examples presented herein.

An example of a possible mode of operation of the flexible schema management system 100 follows. The schema manager 110 accesses a first schema from the mobile computing device 120. The schema manager 110 also accesses a second schema from the personal computer 130. The two schemas are compared to identify differences between the two. Ideally, the two schemas are already stored in a format that makes comparisons easy. However, if that is not the case, the schema manager can convert one or both of the schemas into a format that can facilitate a comparison.

In this example, both the mobile computing device 120 and the personal computer 130 have the ability to make changes to a schema or schemas on the respective devices. It is not necessary for both devices to have this ability so long as at least one device can create a changed schema. As discussed in further detail below in conjunction with later drawings, it is also possible for a changed schema to originate from a third device such as a schema server.

Once differences between the two schemas are identified, the schema manager can determine how to alter each of the schemas to cause the two schemas to match. Additionally or alternatively, the schema manager 110 can determine how to construct a third schema that includes all desired attributes of the first schema and the second schema. Once an alteration plan has been determined the schema manager can change each schema (or create a third schema) in accordance with the alteration plan. If a third schema is created, the schema manager can use the third schema to replace the first schema and the second schema of the mobile computing device 120 and the personal computer 130, respectively.

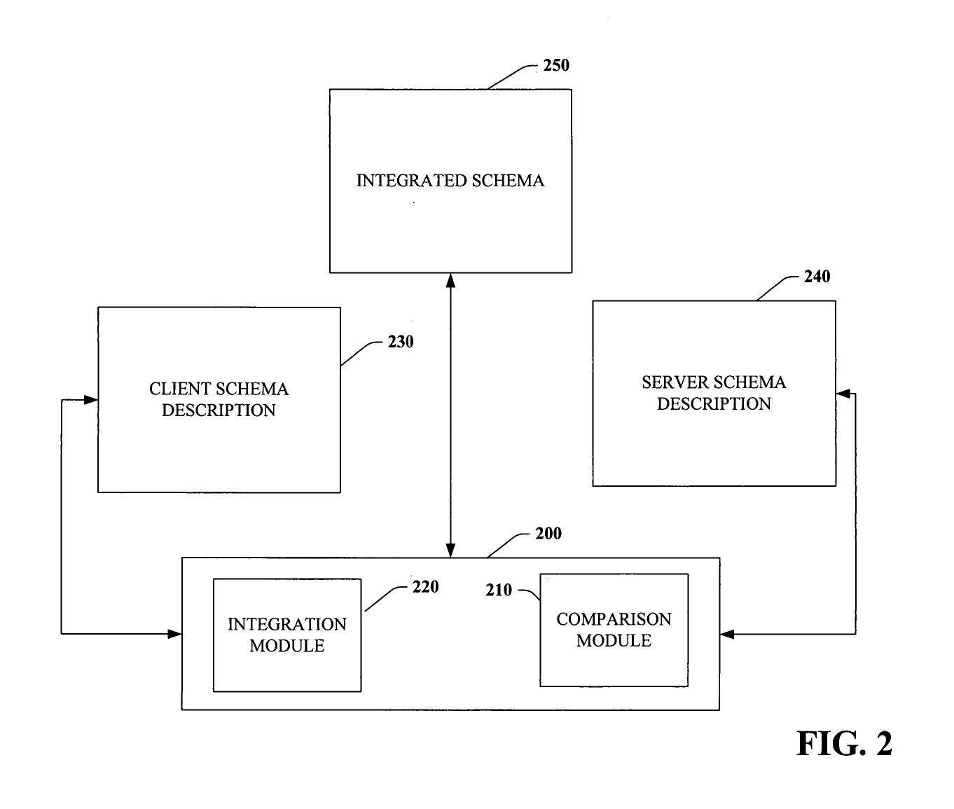

FIG. 2 is a system block diagram of a schema manager 200. The schema manager 200 can provide integration services to modify an existing schema or to use at least some attributes of at least one schema to create a new schema. Specifically, the schema manager 200 can make comparisons between or among schemas, determine how to change schemas to create a desired schema, and create a desired schema. Additionally, the schema manager 200 can convert between or among various formats that can be used to represent or store schemas and can make comparisons of schemas using those formats.

The schema manager 200 includes a comparison module 210. The comparison module 210 can access a client schema description 230 and a server schema description 240. The client schema description 230 and the server schema description 240 can be representations of the schemas themselves or can be another description that is derived from the schemas. In either case, the client schema description 230 and the server schema description 240 can include full descriptions of the respective schemas and are in the same format. Alternatively, the client schema description 230 and the server schema description 240 can be an indicator of a portion of a schema that has changed along with a description of a type of change that applies, for example, an addition, a deletion, or a change of data format such as date or time. Also, the client schema description 230 and the server schema description 240 can be different formats.

The comparison module 210 can compare attributes of schemas to each other and identify differences between or among compared schemas. In the case where the client schema description 230 and the server schema description 240 are of different formats, the comparison module 210 can convert one of each format to the format of the other schema. Additionally or alternatively, the comparison module 210 can convert both of the compared schemas to a common third format for comparison. Details of such comparison are largely dependent upon a specific implementation and format used to represent the schema.

An integration module 220 is also included in the schema manager 200. The integration module 220 can use information from the comparison module 210 that relates to differences in compared schemas to merge schema attributes to modify schemas to match each other or to create a new schema. In either case, a resulting integrated schema can be created by the schema manager 200.

An example of the schema manager 200 in operation follows. The comparison module 210 accesses the client schema description 230 and the server schema description 240 to obtain information about the structure of each of the two schemas. The comparison module 210 then compares the two schemas to ensure that the schemas are in a common format or in compatible formats that can be compared directly. If not, the comparison module converts one or both of the schemas to a format that facilitates comparison.

The comparison module 210 identifies differences between the schemas and sends information about those differences to the integration module 220. The integration module 220 determines how to modify each schema to match the schemas together or how to create a third schema. Such determination can be affected by preferences such as specifics regarding how to treat additions or deletions, and whether preference should be given to changes that originated from a client or a server. The integration module 220 then creates the integrated schema 250.

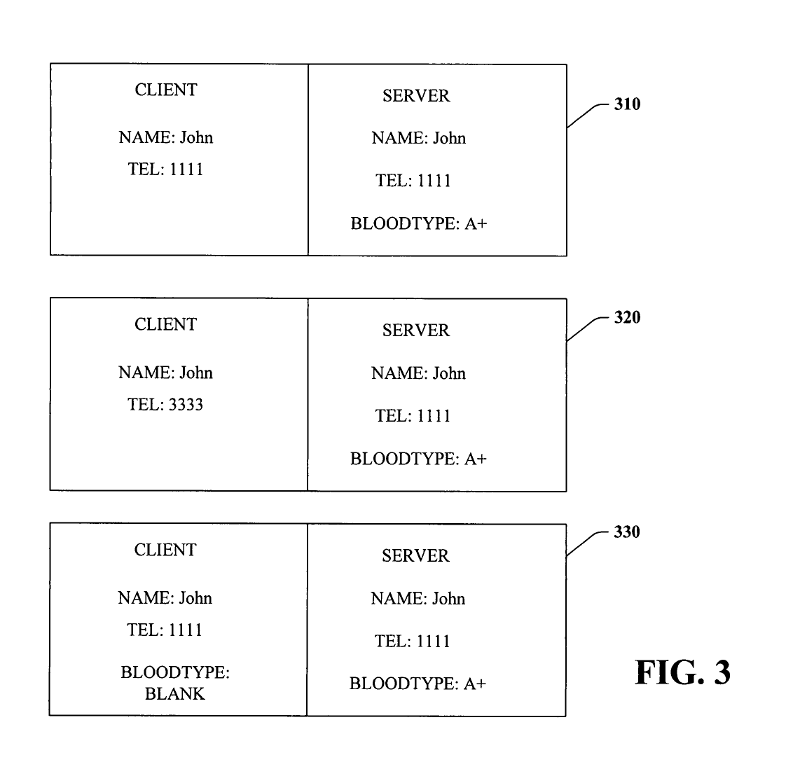

FIG. 3 is a block diagram that illustrates corresponding client and server data records at different stages in time. A first data record 310 includes corresponding client and server sides. The data record is depicted as having two sides, for information resident on the client and information resident on the server, for ease of comparison and discussion. Those of ordinary skill in the art will recognize that the data record 310 is representational and does not show an actual data structure.

On the client side, information in the data record 310 is represented according to a predefined schema. Included fields are a NAME field to hold a name and a TEL field to hold a telephone number. On the server side, fields include matching NAME and TEL fields as well as an additional BLOODTYPE field. The BLOODTYPE field is intended to hold information relating to a blood type. As can be seen, the server schema has been extended by the addition of the BLOODTYPE field. If a synchronization was to occur at this point, BLOODTYPE information from the server lacks a place in the schema of the client and could not be transferred.

Data record 320 is a snapshot of the data record 310 at a later point in time. The data record 320 has had data changed. Specifically, the TEL field on the client side of the data record 320 includes changed information. During a synchronization process between the client and the server, the changed value from the server can overwrite the corresponding value on the server. However, at this point in time, the schema of the client still does not match the schema of the server. This mismatch will make any synchronization at this point problematic.

A snapshot of the data record at a third point in time is shown as data record 330. At this point, the BLOODTYPE field that formerly was present only in the server schema has been added to the schema of the client. The BLOODTYPE field of the client is blank. A subsequent synchronization can occur with no data loss. In this example, however, a potential data synchronization conflict can occur.

Typical systems synchronize data at a fairly high level of granularity. An entire record is usually marked with an identifier that is used to determine whether the record should be overwritten with new information or used to overwrite a corresponding record. In this case, after the schemas for the client and server are matched, marking either of the records will cause some data loss. If the client portion is used to update the server potion, the client will not obtain the BLOODTYPE information from the server. If the server portion is used to update the client, the updated TEL information of the client will be overwritten with old information from the server.

There are at least two solutions to this problem. First, after matching schemas, a synchronization process can be run at the record level. If the client copy is used to update the server, the server can obtain the new TEL information from the client. At that point, the server copy can be marked to indicate that the record has changed and should be used to update the client. This process can be referred to as identifying an artificial change. A second synchronization process can then transfer the BLOODTYPE information from the server to the client. Following the second synchronization process, both the client and the server will have complete and correct information.

A second approach involves synchronizing at a finer level of granularity. In this approach, each field within a record can be updated individually. Following a schema match, a single synchronization process can be run with appropriate data overwrites from client to server and vice-versa occurring for each individual field instead of overwriting entire records. In this manner, the synchronization problems discussed above can be avoided.

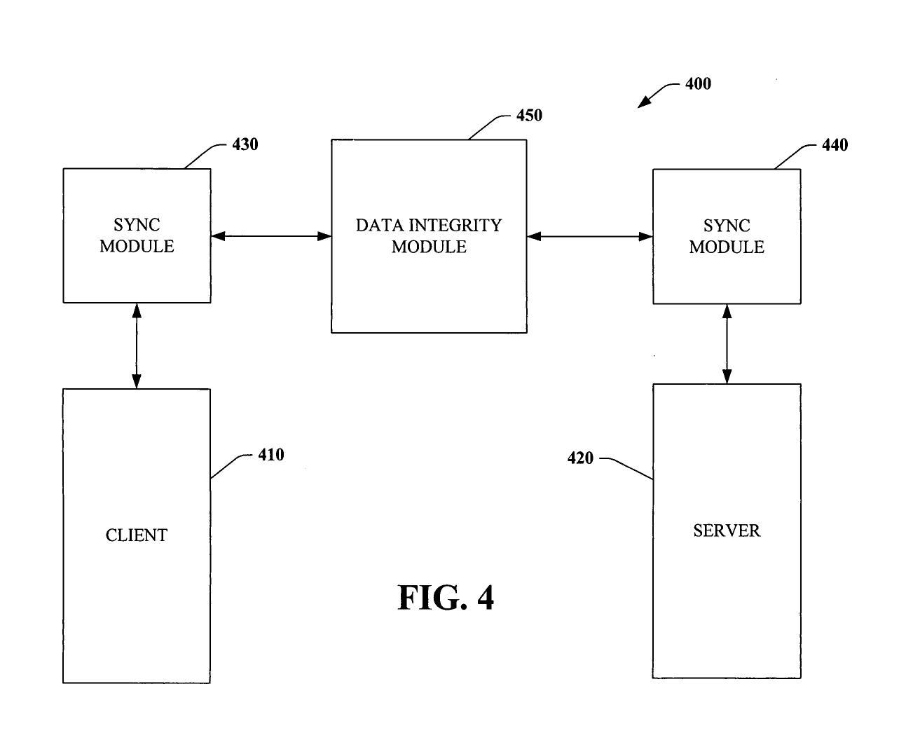

FIG. 4 is a system block diagram of a flexible schema synchronization system 400. The flexible schema synchronization system 400 can provide data integrity functions for data synchronization tasks. Specifically, the flexible schema synchronization system 400 can identify data alteration or corruption and either alert a user or automatically take some action.

The flexible schema synchronization system 400 includes a client 410 that can synchronize data with a server 420. The client 410 and the server 420 can each use an associated synchronization module 430, 440. Each of the synchronization modules 430, 440 can include a schema management module so that changes to schemas can be made to both the server 420 and the client 410. In addition, the synchronization modules 430, 440 can provide data synchronization services to ensure that sets of data on the client 410 and the server 420 remain consistent and correct.

A data integrity module 450 can monitor data traffic between the client 410 and the server 420. Specifically, the data integrity module 450 can determine whether transferred data has been altered, whether such alteration results from transmission errors or from outside tampering. A number of methods can be used to detect tampering. Among those methods are the application of digital signatures, cyclic redundancy checks, hash functions, and other similar methods.

An example of operation of the flexible schema synchronization system 400 follows. The client 410 initiates a synchronization session with the server 420. The synchronization module 430 manages data transfer tasks for the client and applies a hash function to data to be transferred. Data top be transferred includes first, schema-related data and second, information that is formatted in accordance with the schema. The data integrity module 450 receives the information from the synchronization module 430. The received data is checked against the applied hash function to determine whether the data is intact. If so, the data integrity module 450 forwards the data to the synchronization module 440 of the server 420. A similar process happens for communications originating from the server 420 directed to the client 410.

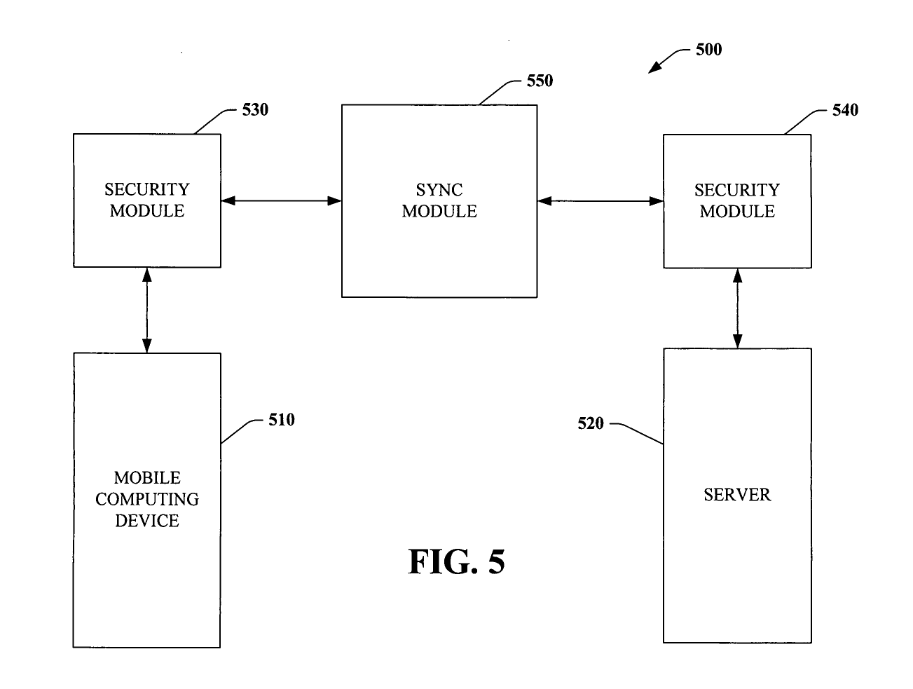

FIG. 5 is a system block diagram of a secure flexible schema and synchronization system 500. The secure flexible schema and synchronization system 500 can provide a framework upon which secure data communications can occur. These secure data communications can include schema updates and data synchronization tasks.

The secure flexible schema and synchronization system 500 includes a mobile computing device 510 and a server 520. The mobile computing device 510, in this example, acts as a client that has data to be synchronized with the server 520. Both the mobile computing device 510 and the server 520 have associated security modules 530, 540. The security modules 530, 540 can protect data sent between the mobile computing device 510 and the server 520. Such protection can be accomplished in a variety of ways. Among the ways specifically contemplated are encryption systems, including symmetric private key systems and asymmetric public-private key systems. In such a system, one of the security modules 530, 540 can encrypt data communication from the mobile computing device 510 to the server 520, or vice-versa. The other one of the security modules 530, 540 can decrypt the data before providing the contents of the data to the mobile computing device 510 or the server 520, as appropriate.

A synchronization module 550 can interact with the mobile computing device 510 and the server 520. The synchronization module 550 can provide both schema synchronization and data synchronization tasks. One of the synchronization components discussed previously in connection with other figures can be used as a basis for the synchronization module 550. Additionally, the synchronization module 550 can handle encrypted data communications in the performance of synchronization tasks.

An operational example of the functioning of the secure flexible schema and synchronization system 500 follows. The mobile computing device 510 establishes a synchronization session with the server 520 by using the synchronization module 550. Data transmissions from the mobile computing device 510 to the server 520, including data transmissions related to schema update operations, are routed first to the security module 530. The security module 530 uses an appropriate system to encrypt or otherwise protect the data transmissions. The security module 550 then sends the protected data transmissions to the synchronization module 550.

The synchronization module 550 manages the protected data transmission from the security module 530 and directs those transmissions to the security module 540. The security module 540 then removes the protection from the data transmissions and forwards the data transmissions to the server 520. The server 520 uses the data transmissions to update its data. A similar process is applied for transmissions that originate at the server 520 and are directed to the mobile computing device 510.

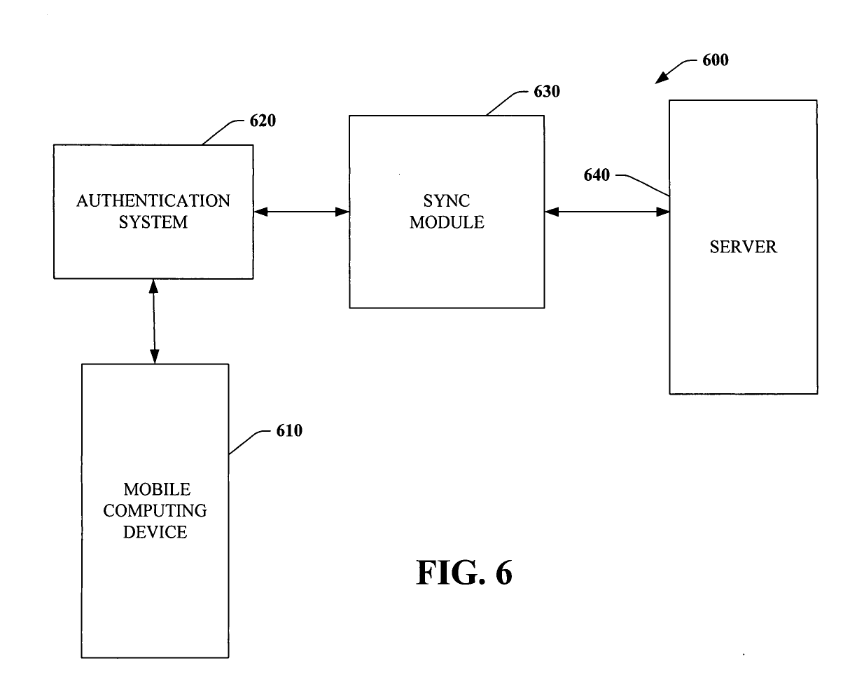

FIG. 6 is a system block diagram of a secure authentication system including schema synchronization capabilities 600. The secure authentication system including schema synchronization capabilities 600 can provide a platform upon which users of mobile computing devices and mobile computing devices themselves can be authenticated prior to engaging in schema update or data synchronization processes.

The secure authentication system including schema synchronization capabilities 600 includes a mobile computing device 610. The mobile computing device 610 can be any of the mobile computing devices previously described in conjunction with other figures or can be another type of mobile device. The mobile computing device 610 can access an authentication system 620 to obtain identification services prior to engaging in schema update or data synchronization tasks.

The authentication system 620 can authenticate a user of a mobile computing device, such as the mobile computing device 610, to ensure that the user of the mobile computing device is authorized to access the secure authentication system 600. The authentication system can include a user authentication component that uses a system that is based upon a basic security paradigm. Authentication can be based upon concepts of who you are, what you have, and what you know, among others.

Biometric systems are included in the category of systems that are based on who you are. Such systems can include fingerprint based systems that attempt to match a fingerprint of a user with a fingerprint of a known and authorized user. Also possible are retina scan systems that scan a retina of a user and attempt to match that retina scan with a retina scan of a known and authorized user. Other biometric-based systems can also be used.

In the category of what a user has are systems that use identification tokens or secure passcards. When using an identification token, the user can be required to enter information from the token to the system. The token is keyed to the authentication system such that the authentication system always knows what the token is displaying for entry. When using a passcard, a user can be required to present the passcard in a reader to access the system. Other systems in this category are also possible.

Finally, in the category of what you know are systems that require entry of a username and password. The usernames and passwords of authorized users can be matched against the username and password provided by a user of a mobile computing device. If a match is found, the user can be granted access. It will be apparent to those of ordinary skill in the art that various combinations of some or all of these systems, or others, can be employed. Such an implementation is largely a matter of design choice during implementation.

The authentication system 620 can also act to authenticate a mobile computing device that attempts to establish a synchronization session, such as the mobile computing device 610. This can be accomplished by a variety of means. One possible approach is for the authentication system 620 to obtain a unique identifier of the mobile computing device 610. This obtained unique identifier can then be matched against a list of known and authorized mobile computing devices. Access to the system 600 can be determined by the presence or absence of the identifier of the mobile computing device 610 on an access control list.

Another approach is to generate a unique identifier of a mobile computing device, such as the mobile computing device 610, by accessing various persistent attributes of the mobile computing device, such as model or serial numbers of component parts, among other things. As with the previous scheme, the derived unique identifier is checked against a group of identifiers for known and authorized devices. A device must be previously authorized to have its identifier included in the group of identifiers. Consequently, unknown devices will not be able to obtain access.

The authentication system 620 can control access to a synchronization module 630. The synchronization module 630 can be one of the synchronization modules discussed in conjunction with other figures. Specifically, the synchronization module 630 can provide schema update functions as well as data synchronization services. In doing so, the synchronization module 630 can access a server 640. The synchronization module 630 can manage schema updates and data synchronization requests traveling between the mobile computing device 610 and the server 640. Such management functions can be controlled by the authentication system 620.

An example of the secure authentication system including schema synchronization capabilities 600 in operation follows. The mobile computing device 610 can attempt to establish a schema update and synchronization session with the server 640. To do so, the mobile computing device sends an authentication request to the authentication system 620. The authentication system 620 first attempts to establish whether the mobile computing device is an authorized device by using one of the previously described methods. If the device cannot be authenticated, access will be denied by the authentication system 620.

If the mobile computing device 610 can be authenticated, the authentication system 620 will attempt to authenticate a user of the mobile computing device 610. Again, one of the previously discussed methods for authenticating a user can be used. If the user of the mobile computing device 610 is authenticated, the authentication system 620 will grant access to the mobile computing device 610.

The mobile computing device 610 then establishes a schema update and data synchronization session with the server 640 by using the synchronization module 630. The synchronization module 630 can use one or more of the previously described techniques to update a schema of the mobile computing device 610 or the server 640, or both. The synchronization module 630 then coordinates a data synchronization routine between the mobile computing device 610 and the server 640. Upon completion, the mobile computing device 610 and the server 640 each have consistent and correct schemas and data.

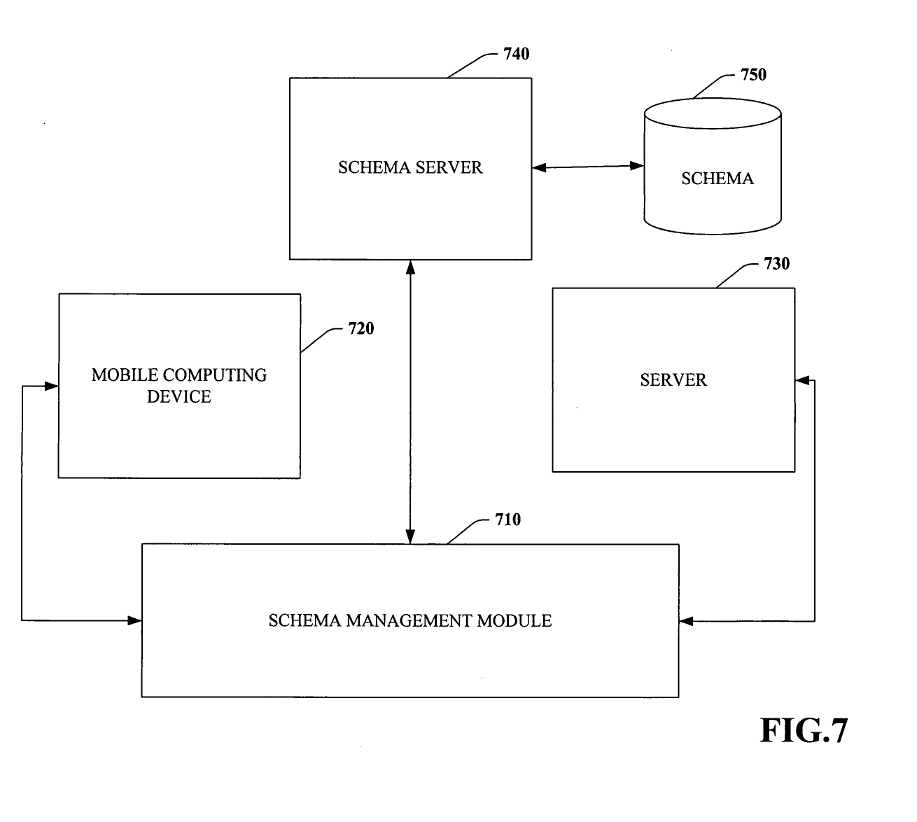

FIG. 7 is a system block diagram of a schema update system 700. The schema update system includes a schema management module 710. The schema management module 710 can access a schema from a mobile computing device 720. A schema from a server 730 can also be accessed by the schema management module 710. Previously described schema update and management functions can be employed by the schema management module 710.

In addition, the schema management module 710 can access a schema server 740. The schema server 740 can access a schema data store 750. The schema management module 710 can submit a schema descriptor to the schema server 740. The schema server 740 can search the schema data store 750 to find a schema that is an exact or approximate match to the schema described. The schema server 740 can send the matched schema to the schema management module 740 which can use the matched schema to update one or more schemas of the mobile computing device 610, the server 640, or both.

This system can be especially useful where a user desires to modify a schema but is not sure how or does not wish to go through a potentially complex schema design process. In these cases, among others, the user can select a group of certain defining attributes for a schema. The schema management module 710 can then create a descriptor for a general schema that includes the attributes defined by the user. The schema server can then access a group of previously designed schemas to locate a schema that is at least close to the schema described by the user.

In operation, the schema update system 700 can function as follows. The mobile computing device 720 can send a schema descriptor to the schema management module 710. The schema management module 710 then accesses a schema from the server 730 to determine whether to update the schema of the mobile computing device 720 by using a schema from the server 730. If the schema from the server 730 is not to be used to update a schema of the mobile computing device, the schema management module 710 can send the schema descriptor to the schema server 740. The schema server 740 can search the schema data store 750 to locate a matching schema. That matching schema can be either an exact match or an approximate match. In either case, the matching schema is sent by the schema server 740 to the schema management module 710. The schema management module 710 then uses the schema from the schema server 740 to update schemas of both the mobile computing device 720 and the server 730. The updates schemas of the mobile computing device 720 and the server 730 are then used in subsequent data synchronization processes.

The disclosed and described components, for example in connection with detection or identification tasks, can employ various artificial intelligence-based schemes for carrying out various aspects thereof. For example, various comparison or matching functions can be performed by an artificial intelligence-based component. Moreover, when more than one component is in use, an automatic classifier system can be used to identify operational parameters that deviate from the norm.

A classifier is a function that maps an input attribute vector, X=(x₁, x₂, x₃, x₄, . . . , xₙ), to a confidence that the input belongs to a class, that is, f(X)=confidence(class). Such a classification can employ a probabilistic and/or statistical-based analysis (for example, factoring into the analysis utilities and costs) to prognose or infer an action that a user desires to be automatically performed. In the case of flexible schema systems, for example, attributes can be data field descriptors and data types or other data-specific attributes derived from the schema and the classes are categories or areas of interest, for example, descriptors of other schemas that the schema manager can use.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naive Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the disclosed and described components can employ classifiers that are explicitly trained (for example, by a generic training data) as well as implicitly trained (for example, by observing user behavior, receiving extrinsic information). For example, SVMs are configured by a learning or training phase within a classifier constructor and feature selection module. Thus, the classifier(s) can be used to automatically perform a number of functions including but not limited to determining whether a device should be sent data.

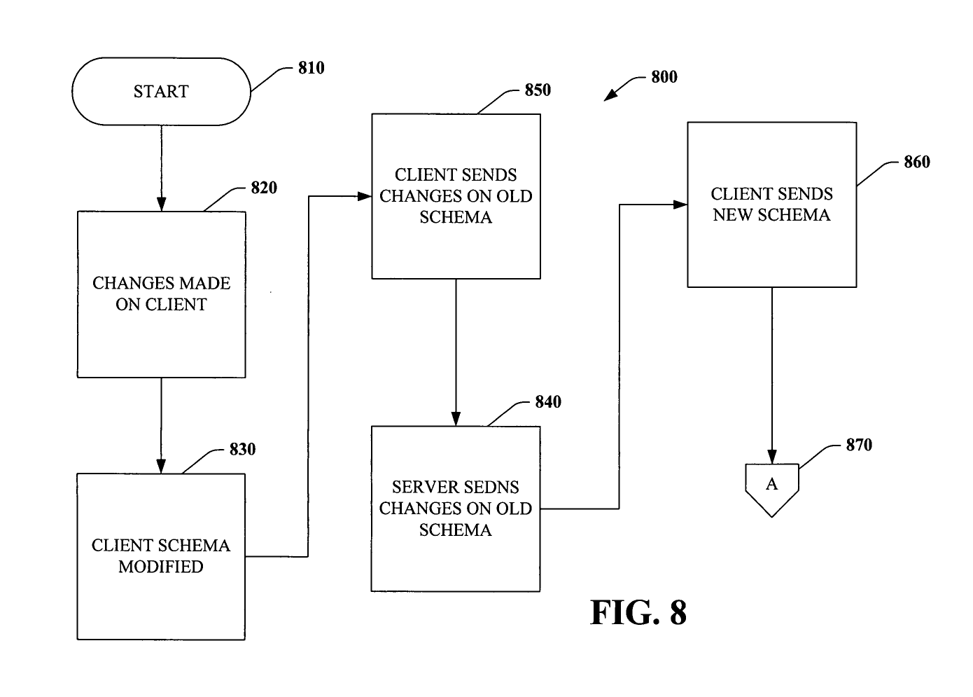

With reference to FIGS. 8-13, flowcharts in accordance to various methods that can be employed with the components disclosed and described herein are presented. While, for purposes of simplicity of explanation, the one or more methodologies shown herein, for example, in the form of a flow chart, are shown and described as a series of acts, it is to be understood and appreciated that the subject invention is not limited by the order of acts, as some acts can occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

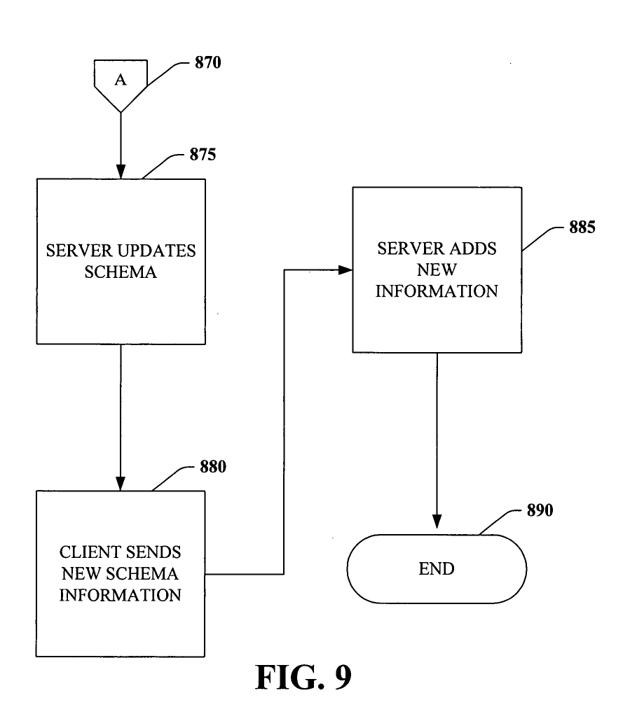

FIGS. 8 and 9 are portions of a flow diagram that depicts a method that can be used. The method can be used to accomplish a general schema update and data synchronization. Such a schema update and associated data synchronization can occur not only at a start-up point for processing but also at any point during runtime.

Processing of the method begins at START block 810 and continues to process block 820. At process block 820, changes in data are made on a client. Such changes can be, for example, a changed phone number in a contact item or a new address for a contact. Processing continues to process block 830 where a schema on the client is modified. Such modification can be the addition of a field, such as a field for an email address, to the schema for contact information.

At process block 840, the client sends changes to a synchronizing server using a form of the schema as it existed prior to modification. The server sends changes to the client in accordance with the old schema at process block 850. Processing continues at process block 860 where the client sends information describing the new schema to the server. Continuation block 870 designates that the flow diagram continues off page at FIG. 9.

FIG. 9 is a continuation of the flow diagram of FIG. 8. From the continuation block 870, processing continues to process block 875. At process block 875, the server updates its schema in accordance with the schema information sent to it by the client. At process block 880, the client sends information that is described by the new schema to the server. Processing continues to process block 885. At process block 885, the server adds new information from the client to its records. Processing concludes at END block 890.

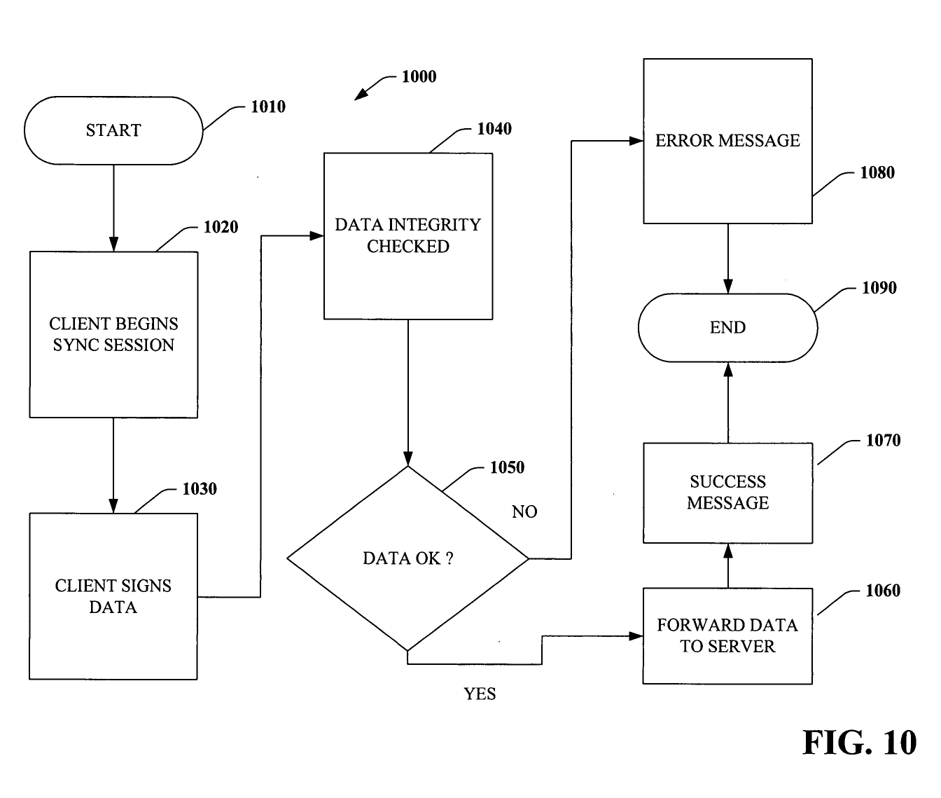

FIG. 10 is a flow diagram of a method 1000 that can be used. Processing of the method 1000 begins at START block 1010 and continues to process block 1020. At process block 1020, a client begins a synchronization session. Processing continues to process block 1030 where the client digitally signs data to be synchronized with a server. Integrity of that data is checked by an integrity module at process block 1040.

Processing continues to decision block 1050 where a determination is made whether the data signed by the client is intact. If that determination is yes, processing continues to process block 1060 where the data is forwarded to the server. Processing then continues to process block 1070 where a success message is generated. Processing concludes at END block 1090.

If the determination made at decision block 1050 is no, usually meaning that the data has been corrupted or tampered with by a third party, processing continues to process block 1080. At process block 1080, an error message that indicates that synchronization did not complete successfully is generated. Processing then terminates at END block 1090.

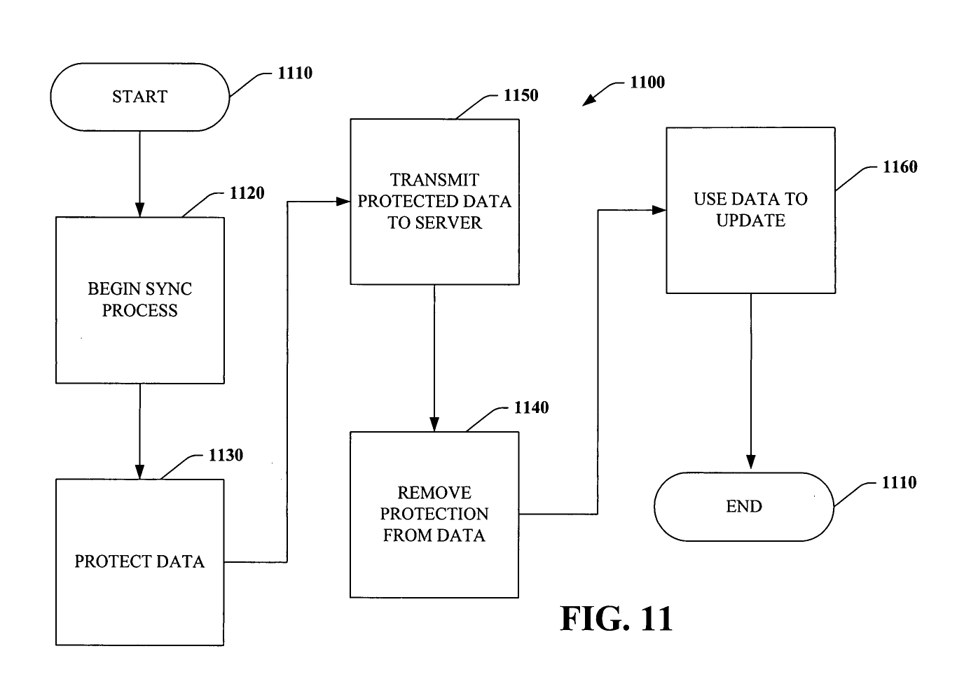

FIG. 11 is a flow diagram of a general processing method 1100 that can be employed. Processing begins at START block 110 and continues to process block 1120. At process block 1120 a synchronization process is begun by a client. At process block 1130, the client protects data to be sent to a server for synchronization. Protection can be accomplished using one of the encryption schemes described above in conjunction with other figures or another suitable system can be used.

Processing continues to process block 1140 where the protected data is sent to the server. At process block 1150, the protection applied to the data by the client is removed by the server. The server then uses the data to update its records at process block 1160. Processing terminates at END block 1170.

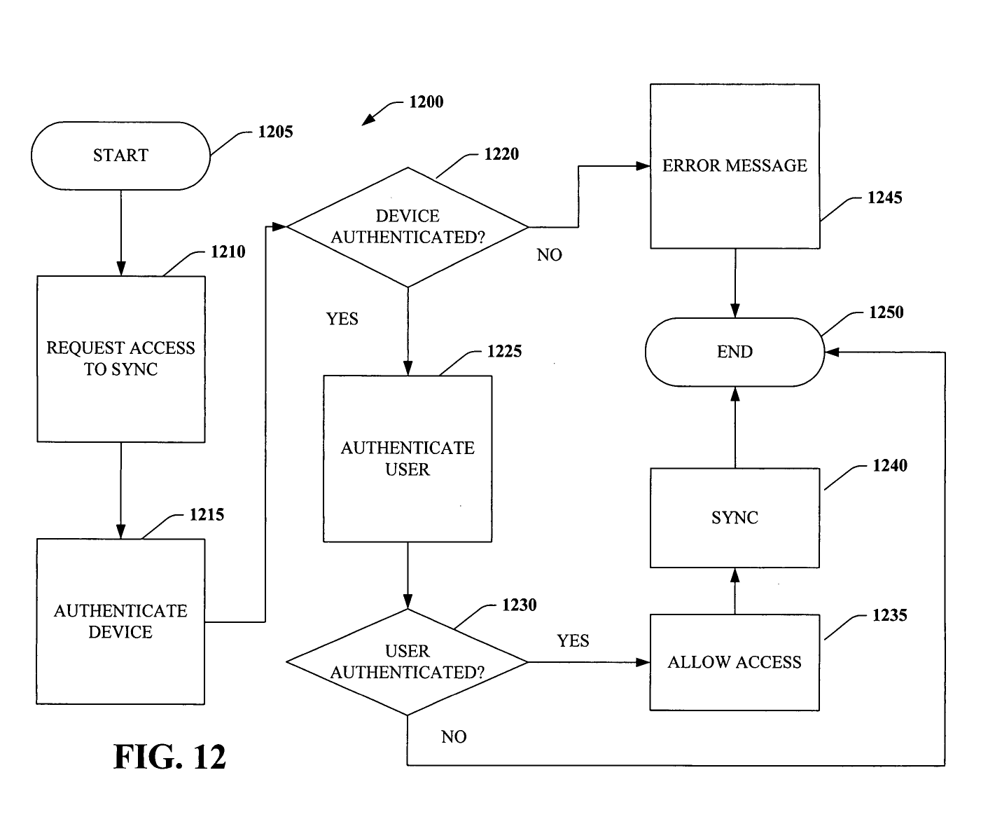

FIG. 12 is a flow diagram of a general processing method 1200 that can be used. Processing of the method 1200 begins at START block 1205 and continues to process block 1210. At process block 1210, a client requests to begin a synchronization session. Processing continues to process block 1215 where an attempt is made to authenticate the client device. Authentication of the client device can be performed using systems and methods described in conjunction with previous figures.

At decision block 1220, a determination is made whether the device has been authenticated. If yes, processing continues to process block 1225 where an attempt is made to authenticate a user of the device. User authentication can be performed according to any of the methods previously discussed in conjunction with other drawings. Processing then continues to decision block 1230 where a determination is made whether the user of the client device has been authenticated.

If the determination made at decision block 1230 is yes, processing continues to process block 1235. At process block 1235, access is allowed to the client device and its user. Processing continues to process block 1240 where a synchronization process occurs. Processing concludes at END block 1250.

If the determination made at decision block 1220 is no, indicating that the client device cannot be authenticated, processing continues to process block 1245 where an error message is generated. Processing from process block 1245 concludes at END block 1250. Similarly, if the determination made at decision block 1230 is no, indicating that the user of the client device cannot be authenticated, processing continues to process block 1245 and thereby to END block 1250.

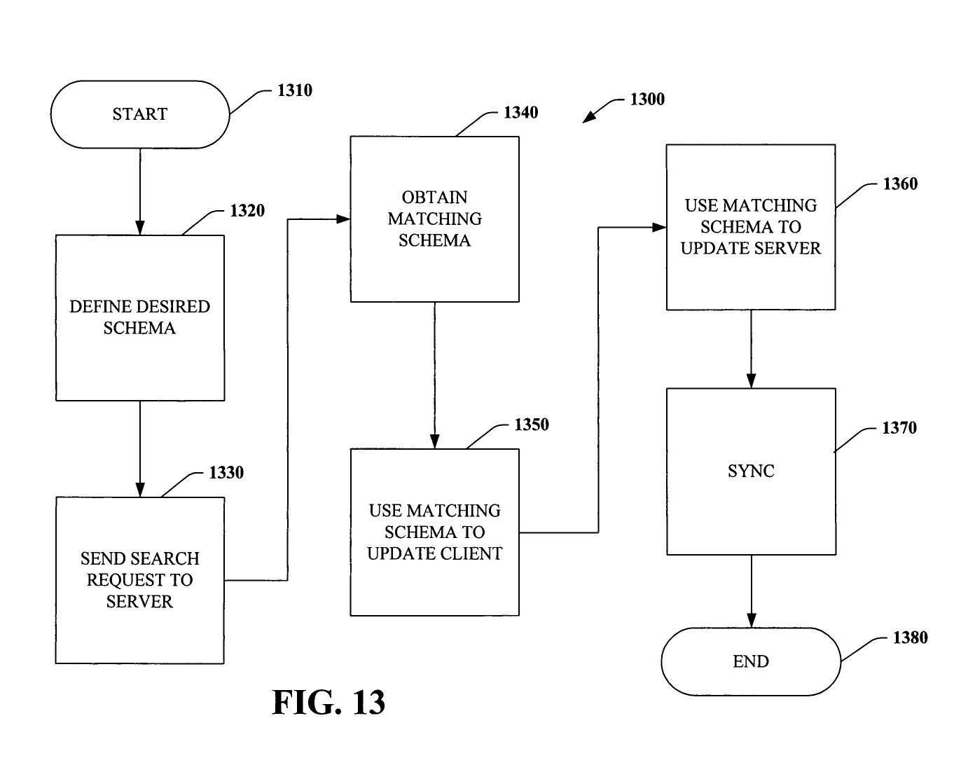

FIG. 13 is a flow diagram of a general processing method 1300 that can be used. Processing of the method 1300 begins at START block 1310 and continues to process block 1320 where a desired schema is defined or described. A search request for such a schema is sent to a schema server at process block 1330. At process block 1340, an exact or close match for the desired schema is obtained.

Processing continues to process block 1350 where the matched schema is used to update a schema on a client device. At process block 1360, the matched schema is used to update a schema on a server device. Processing continues to process block 1370 where a synchronization process using the updated schemas occurs. Processing terminates at END block 1380.

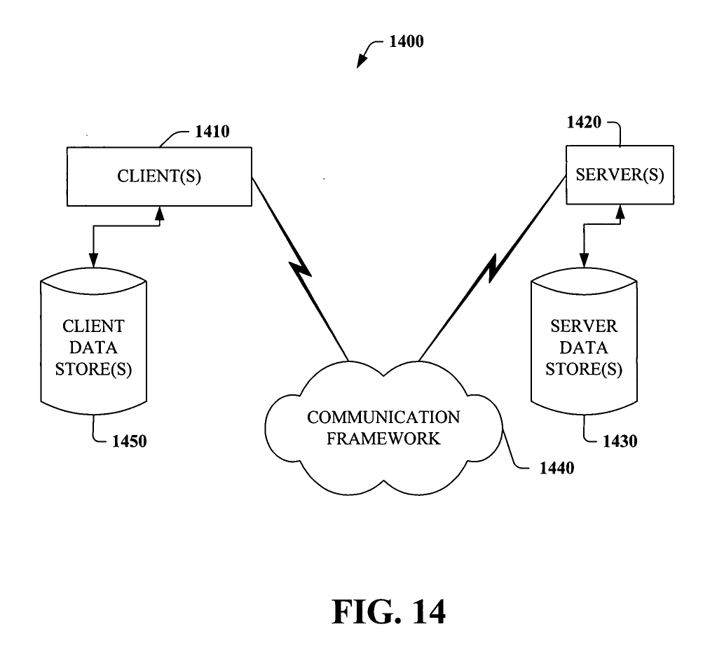

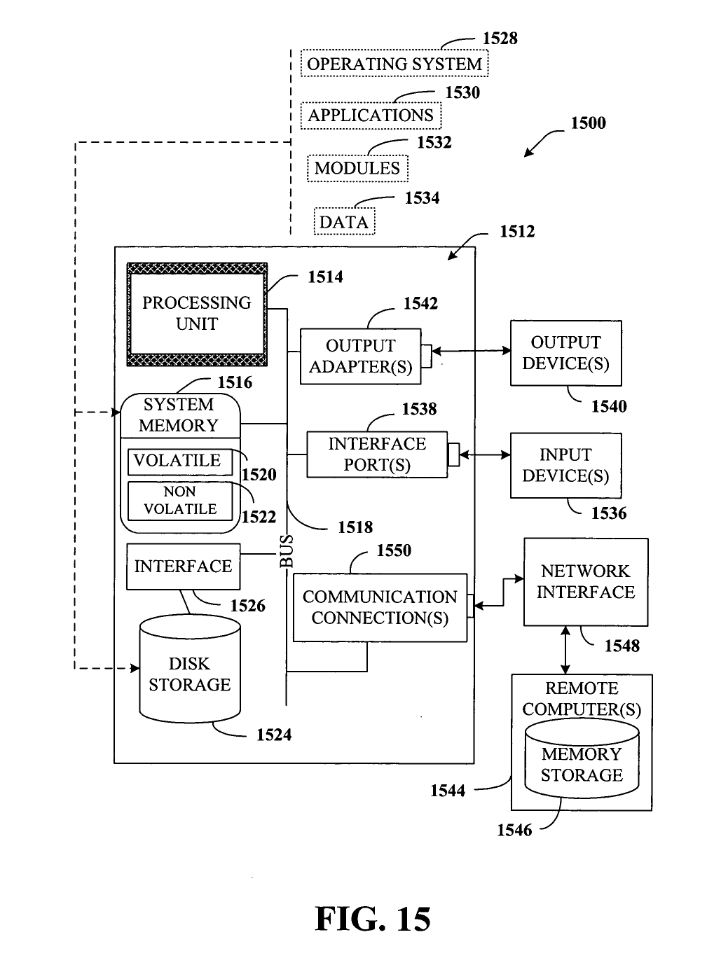

In order to provide additional context, FIGS. 14-15 and the following discussion is intended to provide a brief, general description of a suitable computing environment. While the disclosed and described components and methods have been described above in the general context of computer-executable instructions of a computer program that runs on a local computer and/or remote computer, those skilled in the art will recognize that the disclosed and described components and methods also may be implemented in combination with other program modules. Generally, program modules include routines, programs, components, data structures, etc., that perform particular tasks and/or implement particular abstract data types.

Moreover, those skilled in the art will appreciate that the disclosed and described methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated examples may also be practiced in distributed computing environments where certain tasks are performed by remote processing devices that are linked through a communications network. However, some, if not all, implementations of examples may be practiced on stand-alone computers. In a distributed computing environment, program modules may be located in local and/or remote memory storage devices.

FIG. 14 is a schematic block diagram of a sample-computing environment 1400. The system 1400 includes one or more client(s) 1410. The client(s) 1410 can be hardware and/or software (e.g., threads, processes, computing devices). The system 1400 also includes one or more server(s) 1420. The server(s) 1420 can be hardware and/or software (e.g., threads, processes, computing devices). The servers 1420 can house threads or processes to perform transformations by employing the subject invention, for example.

One possible means of communication between a client 1410 and a server 1420 can be in the form of a data packet adapted to be transmitted between two or more computer processes. The system 1400 includes a communication framework 1440 that can be employed to facilitate communications between the client(s) 1410 and the server(s) 1420. The client(s) 1410 are operably connected to one or more client data store(s) 1450 that can be employed to store information local to the client(s) 1410. Similarly, the server(s) 1420 are operably connected to one or more server data store(s) 1430 that can be employed to store information local to the servers 1440.

With reference to FIG. 15, an exemplary environment 1500 for implementing various components or methods includes a computer 1512. The computer 1512 includes a processing unit 1514, a system memory 1516, and a system bus 1518. The system bus 1518 couples system components including, but not limited to, the system memory 1516 to the processing unit 1514. The processing unit 1514 can be any of various available processors. Dual microprocessors and other multiprocessor architectures also can be employed as the processing unit 1514.

The system bus 1518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1516 includes volatile memory 1520 and nonvolatile memory 1522. The basic input/output system (BIOS), containing the basic routines to transfer information between elements within the computer 1512, such as during start-up, is stored in nonvolatile memory 1522. By way of illustration, and not limitation, nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1512 also includes removable/non-removable, volatile/non-volatile computer storage media. For example, FIG. 15 illustrates a disk storage 1524. The disk storage 1524 includes, but is not limited to, devices like a magnetic disk drive, floppy disk drive, tape drive, Jaz drive, Zip drive, LS-100 drive, flash memory card, or memory stick. In addition, disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface is typically used such as interface 1526.

It is to be appreciated that FIG. 15 describes software that acts as an intermediary between users and the basic computer resources described in the suitable operating environment 1500. Such software includes an operating system 1528. The operating system 1528, which can be stored on the disk storage 1524, acts to control and allocate resources of the computer system 1512. System applications 1530 take advantage of the management of resources by operating system 1528 through program modules 1532 and program data 1534 stored either in system memory 1516 or on disk storage 1524. It is to be appreciated that the disclosed and described components and methods can be implemented with various operating systems or combinations of operating systems.

A user enters commands or information into the computer 1512 through input device(s) 1536. The input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1514 through the system bus 1518 via interface port(s) 1538. Interface port(s) 1538 include, for example, a serial port, a parallel port, a game port, and a universal serial bus (USB). Output device(s) 1540 use some of the same type of ports as input device(s) 1536. Thus, for example, a USB port may be used to provide input to computer 1512, and to output information from computer 1512 to an output device 1540. Output adapter 1542 is provided to illustrate that there are some output devices 1540 like monitors, speakers, and printers, among other output devices 1540, which require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

Computer 1512 can operate in a networked environment using logical connections to one or more remote computers, such as remote computer(s) 1544. The remote computer(s) 1544 can be a personal computer, a server, a router, a network PC, a workstation, a microprocessor based appliance, a peer device or other common network node and the like, and typically includes many or all of the elements described relative to computer 1512. For purposes of brevity, only a memory storage device 1546 is illustrated with remote computer(s) 1544. Remote computer(s) 1544 is logically connected to computer 1512 through a network interface 1548 and then physically connected via communication connection 1550. Network interface 1548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1550 refers to the hardware/software employed to connect the network interface 1548 to the bus 1518. While communication connection 1550 is shown for illustrative clarity inside computer 1512, it can also be external to computer 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

What has been described above includes examples of the disclosed and described components and methods. It is, of course, not possible to describe every conceivable combination of components or methodologies, but one of ordinary skill in the art may recognize that many further combinations and permutations of the subject invention are possible. Accordingly, is the examples are intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated examples. In this regard, it will also be recognized that a system as well as a computer-readable medium having computer-executable instructions comprising components or for performing the acts and/or events of the various methods disclosed and described herein.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for synchronizing arbitrary information, comprising:
a schema definition module that modifies a property of a first schema such that the first schema can support an arbitrary datum; and
a schema integration module that accesses the first schema and a second schema to modify one of the first schema and the second schema such that the first schema and the second schema match.

2. The system of claim 1, further comprising a synchronization module that synchronizes data in accordance with one of the first schema and the second schema.

3. The system of claim 2, wherein the first schema and the second schema are extensible.

4. The system of claim 3, wherein the synchronization module synchronizes a subset of a set of available data that is formatted in accordance with one of the first schema and the second schema.

5. The system of claim 4, wherein synchronization module selects the subset to be synchronized.

6. The system of claim 4, wherein the subset to be selected is chosen in accordance with a user preference.

7. The system of claim 4, further comprising a data integrity module that verifies accuracy of the synchronized data.

8. The system of claim 7, further comprising a security module that protects the synchronized data.

9. The system of claim 8, wherein the security module protects at least one of the first schema and the second schema.

10. The system of claim 9, further comprising an authentication module that verifies identity of a device that uses the first schema.

11. The system of claim 10, wherein the authentication module verifies an identity of a user of the device.

12. The system of claim 11, wherein the authentication module is one of a username and password system, a security token system, and a biometric identification system.

13. A method for synchronizing arbitrary data, comprising:
modifying a first schema such that the first schema can support an arbitrary data type; and
modifying a second schema to match the first schema such that both the first schema and the second schema can support the arbitrary data type.

14. The method of claim 13, further comprising synchronizing a first set of data that is formatted in accordance with the first schema with a second set of data that is formatted in accordance with the second schema.

15. The method of claim 14, wherein modifying the first schema includes extending the schema during run time to support an additional data type.

16. The method of claim 15, wherein synchronizing the first data set with the second data set includes securing a data transmission.

17. A system for synchronizing arbitrary data, comprising:
means for modifying a first schema such that the first schema can support an arbitrary data type; and
means for modifying a second schema to match the first schema such that both the first schema and the second schema can support the arbitrary data type.

18. The system of claim 17, further comprising means for synchronizing a first set of data that is formatted in accordance with the first schema with a second set of data that is formatted in accordance with the second schema.

19. The system of claim 18, wherein the means for modifying the first schema includes means for extending the schema to support an additional data type.

20. The system of claim 19, wherein the means for synchronizing the first data set with the second data set includes means for securing a data transmission.
